(19) United States
(12) Patent Application Publication
(10) Pub. No.: US 2024/0229540 A1
(43) Pub. Date: Jul. 11, 2024

(54) Door Trim Apparatus and Method for Installing Same

(71) Applicant: Lintel Lift, LLC, Mountain Brook, AL (US)

(72) Inventor: Jeffrey Kennedy, Toney, AL (US)

(73) Assignee: Lintel Lift, LLC, Mountain Brook, AL (US)

(21) Appl. No.: 18/410,779

(22) Filed: Jan. 11, 2024

Related U.S. Application Data
(60) Provisional application No. 63/438,383, filed on Jan. 11, 2023.

(51) Int. Cl. E06B 1/60; E06B 1/52

(52) U.S. Cl. CPC E06B 1/6023; E06B 1/522

(57) ABSTRACT

A trim kit for a structural opening in a structure is provided. The trim kit may include a top cover configured to be affixed to the structure above the structural opening, a side cover configured to be respectively affixed to a side of the structure laterally adjacent to the structural opening, and a top clip track including a mounting portion configured to be affixed to a front surface of the structure above the opening in the structure, and a retaining portion extending outwardly from the mounting portion and configured to receive a topside lip of the top cover.

### CROSS-REFERENCE TO RELATED APPLICATIONS

The present application claims priority to U.S. Provisional Application No. 63/438,383, filed on Jan. 11, 2023, the contents of which are hereby incorporated by reference in their entirety.

### TECHNICAL FIELD

The present disclosure relates generally structural openings in residential and commercial structures, such as windows, doorways, and garage doors, and more particularly to trim components and methods for installing same that enhance the aesthetic appearance thereof.

### BACKGROUND

The edges of structural openings such as windows, doors, garage doors, etc. are often formed by the same material that forms the rest of the structure, such as brick, stone, siding, stucco, etc., which can be aesthetically displeasing. The edges of such openings may also include headers that may be made from unfinished materials such as wood, which may also contribute to an unfinished appearance. For example, FIG. 1 shows a garage door opening 100 that includes a wooden header 110 that horizontally spans the garage door opening 100, as well as two vertical wooden columns 120 on the sides of the garage door opening 100. Many owners of such structures are inclined to add trim components that improve the aesthetic appearance of the edges of such structural openings, however trim components can be difficult and/or expensive to install, may require an expert to install, may lead to leaks if not installed properly, and may not stay affixed to the structure. Therefore there is a need for a trim apparatus that is easy to install, is cost-effective, and prevents leaks between the trim apparatus and the edge of the structural opening.

### SUMMARY

According to an aspect of one or more example embodiments there is provided a trim kit for a structural opening in a structure. The trim kit may include a first top cover configured to be affixed to the structure above the structural opening, and a first side cover configured to be affixed to a lateral side of the structure adjacent to the structural opening. At least one of the first top cover and the second top cover may include a topside lip that is configured to fit within a groove in the structure above or on the lateral side of the structural opening. The trim kit may include a second top cover configured to be affixed to the structure above the structural opening, and a coupling component configured to be coupled to and between the first top cover and the second top cover. The first top cover may be L-shaped, and configured to cover front and bottom faces of the existing structure above the structural opening. The first top cover and the second top cover may be L-shaped, and configured to cover front and bottom faces of the existing structure above the structural opening. The coupling component may be L-shaped.

According to another aspect of one or more example embodiments there is provided trim kit for a structural opening in a structure. The trim kit may include a top cover configured to be affixed to the structure above the structural opening, a side cover configured to be affixed to a side of the structure laterally adjacent to the structural opening, and a top clip track that includes a mounting portion configured to be affixed to a front surface of the structure above the opening in the structure, and a retaining portion extending outwardly from the mounting portion and configured to receive a topside lip of the top cover. The retaining portion may extend at approximately a 90 degree angle from the mounting portion. The retaining portion may include a plurality of barbs to retain the topside lip of the top cover. At least some of the plurality of barbs may be made of a resilient material, and may be oriented toward the mounting portion to resist removal of the topside lip from the mounting portion. The top clip track may include a seal portion affixed to a side of the mounting portion that is opposite the retaining portion. The trim kit may include a first side clip track having a mounting portion configured to be affixed to a down-facing surface of the structure above the opening in the structure, and a retaining portion extending outwardly from the mounting portion and configured to receive a bottom lip of the top cover. The trim kit may also include second and third side clip tracks to affix the side cover to the side of the structure laterally adjacent to the structural opening. The second side clip track may include a mounting portion configured to be affixed to a front face of the structure laterally adjacent to the structural opening, and a retaining portion extending outwardly from the mounting portion and configured to receive a first side lip of the side cover. The third side clip track may include a mounting portion configured to be affixed to a vertical side face of the structure laterally adjacent to the structural opening that is perpendicular to the front face, and a retaining portion extending outwardly from the mounting portion of the third side clip track, and configured to receive a second side lip of the side cover. The retaining portions of the first, second, and third side clip tracks may respectively include a plurality of barbs that are oriented toward their respective retaining portions.

According to another aspect of one or more example embodiments there is provided a method of installing a trim kit for a structural opening in a structure. The method may include affixing a top clip track to the structure above the structural opening, wherein the top clip track may include a mounting portion configured to be affixed to a front surface of the structure above the opening in the structure, and a retaining portion extending outwardly from the mounting portion and configured to receive a topside lip of a top cover. The method may include inserting a topside lip of a top cover into the retaining portion, and affixing the top cover to a down-facing surface of the structure above the structural opening. The step of affixing the top cover to the down-facing surface of the structure above the structural opening may include affixing a first side clip track to the down-facing surface of the structure above the structural opening. The first side clip track may include a mounting portion configured to be affixed to a down-facing surface of the structure above the structural opening, and a retaining portion extending outwardly from the mounting portion and configured to receive a bottom lip of the top cover. The method may include inserting the bottom lip of the top cover into the retaining portion of the side clip track. The method may include affixing a second side clip track to a front vertical face of the structure laterally adjacent to the opening in the structure, affixing a third side clip track to a side vertical face of the structure that is perpendicular to the front vertical face of the structure, and coupling a side cover to the second and third side clip tracks. The second side clip track may include a mounting portion configured to be affixed to the front vertical face of the structure, and a retaining portion extending outwardly from the mounting portion of the second side clip and configured to receive a first lip of the side cover. The third side clip track may include a mounting portion configured to be affixed to the side vertical face of the structure, and a retaining portion extending outwardly from the mounting portion of the third side clip and configured to receive a second lip of the side cover

The retaining portion of the top clip track may extend at approximately a 90 degree angle from the mounting portion. The retaining portion of the top clip track may include a plurality of barbs to retain the topside lip of the top cover. At least some of the plurality of barbs of the top clip track may be made of a resilient material, and may be oriented toward the mounting portion to resist removal of the topside lip from the mounting portion.

According to an aspect of one or more example embodiments, there is provided a clip track for securing a trim piece to an existing structure. The clip track may include a mounting portion configured to be affixed to a surface of an existing structure, a retaining portion extending from a front side of the mounting portion, and configured to receive a lip of the trim piece, a seal portion made of a resilient material and affixed to a back side of the mounting portion, and a plurality of barbs disposed within the retaining portion, and configured to retain the lip of the trim piece.

### BRIEF DESCRIPTION OF DRAWINGS

FIG. 1 illustrates a garage door opening without any trim component according to the prior art.

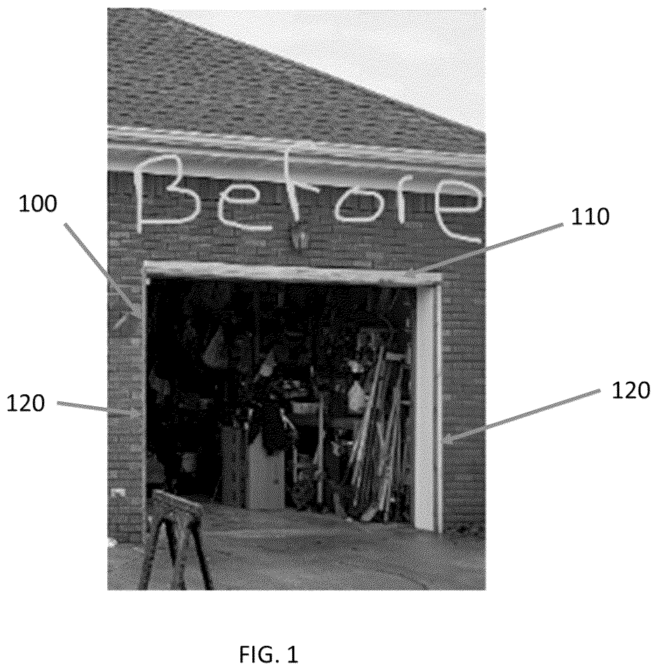

FIG. 2 illustrates a garage door opening with a trim apparatus according to an example embodiment installed.

FIG. 3 illustrates a process of affixing a top cover to a garage door opening according to an example embodiment.

FIG. 4 illustrates a process of affixing a coupling component to two top covers according to an example embodiment.

FIG. 5 illustrates a process of affixing a top cover to a garage door opening according to an example embodiment.

FIG. 6 illustrates a front view of a process of affixing a side cover to a side of a garage door opening according to an example embodiment.

FIG. 7 illustrates an internal side view of a process of affixing a side cover to a side of a garage door opening according to an example embodiment.

FIG. 8 illustrates an external side view of a process of affixing a side cover to a side of a garage door opening according to an example embodiment.

FIG. 9A illustrates a side view of a top clip track for securing a vertical face of a top cover for a lintel above a garage door opening according to an example embodiment.

FIG. 9B shows a perspective view of the top clip track of FIG. 9A, with a top cover being inserted into the top click track.

FIG. 10A illustrates an end view of a side clip track for securing a side cover to a side of a garage door opening or a horizontal face of a top cover to a down-facing surface of the existing structure above a garage door opening, according to an example embodiment.

FIG. 10B illustrates an alternative end view a side clip track for securing a side cover to a side of a garage door opening or a horizontal face of a top cover to a down-facing surface of the existing structure above a garage door opening, according to an example embodiment.

FIG. 10C shows a perspective view of the side clip track shown in FIGS. 10A and 10B.

### DETAILED DESCRIPTION OF EXAMPLE EMBODIMENTS

Reference will now be made in detail to the following example embodiments, which are illustrated in the accompanying drawings, wherein like reference numerals refer to like elements throughout. The example embodiments may be embodied in various forms without being limited to the example embodiments set forth herein. Descriptions of well-known parts are omitted for clarity.

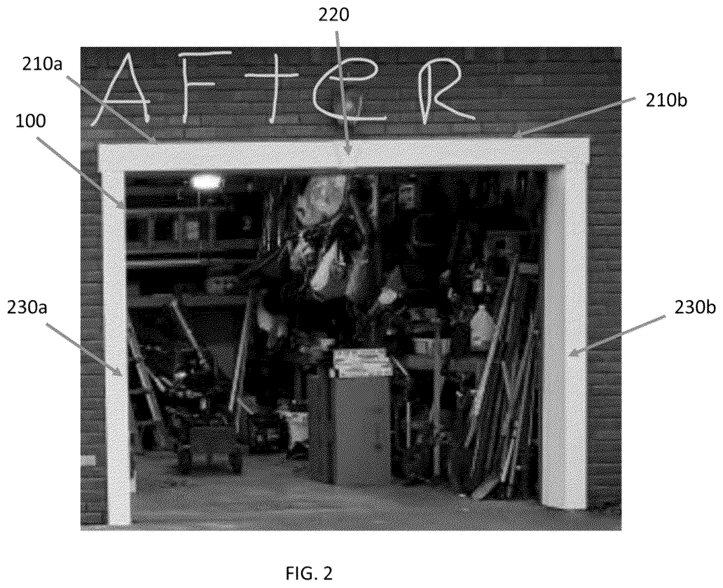

FIG. 2 shows a garage door opening with a trim apparatus according to an example embodiment installed. The trim apparatus may include two L-shaped top covers 210a, 210b that extend horizontally across the garage door opening 100, and are joined in the middle by a coupling component 220. The trim apparatus may also include two L-shaped side covers 230a, 230brespectively affixed to the sides of the garage door opening 100. The L-shaped top covers 210a, 210b and L-shaped side covers 230a, 230b may include locking corners to allow for easier storage and transporting.

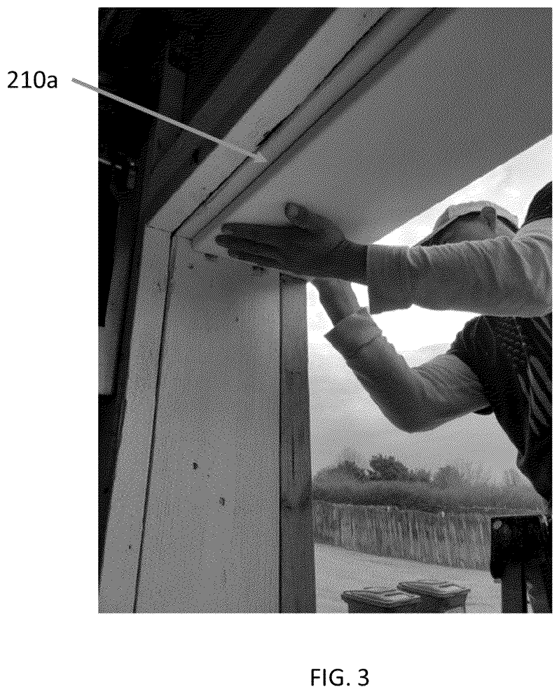

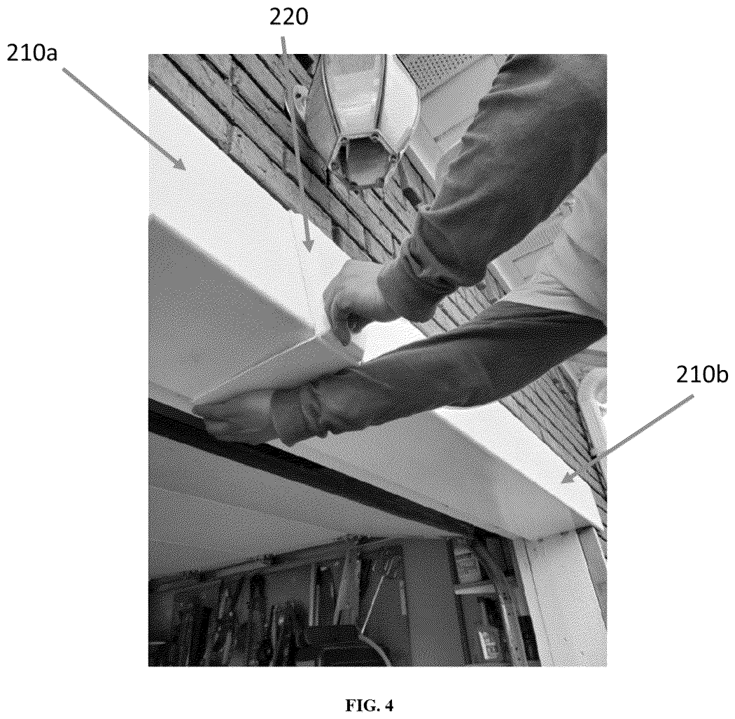

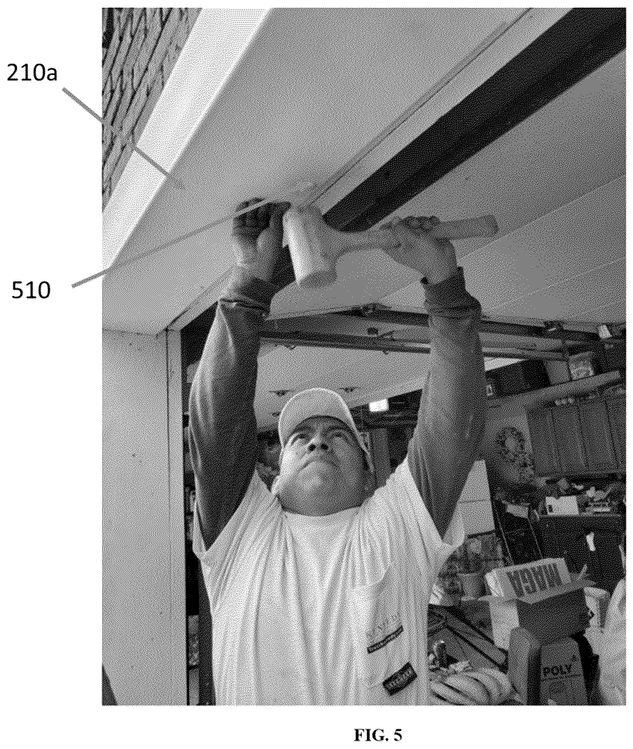

FIG. 3 shows a process of affixing a top cover to a header above the garage door opening, according to an example embodiment. FIG. 4 shows a process of affixing a coupling component to couple two top covers according to an example embodiment. Referring to FIGS. 3 and 4, one or more top covers 210 (or 210a and 210b, as shown in the example of FIG. 2 that includes two top covers) may be used to horizontally span the existing structure above the garage door opening 100. For example, a reglet, or groove, may be cut into the masonry above the garage door opening 100. The one or more top covers 210a, 210b may include a topside lip having a cross sectional shape configured to fit within the reglet. For example, if the reglet or groove is roughly square-shaped, the topside lip of the top cover(s) 210a, 210b may have a C-shaped cross-section to fit within the reglet or groove. Other shaped reglets may also be used without departing from the present disclosure. The topside lip of the top cover(s) 210a, 210b may be installed into the reglet or groove in the masonry with a bead of silicone caulk that fastens the topside lip of the top cover 210a, 210b within the reglet or groove. Vertical faces of the L-shaped top covers 210a, 210b cover the front exterior face of the structure, while horizontal faces of the top covers 210a, 210b extend underneath and over the down-facing surface of the structure above the opening, altogether sealing the kit and original building material (including the original steel lintel and metal fasteners) against water, rust erosion and air infiltration (weather). This method of installing the top covers 210a, 210b may add sun protection to the otherwise exposed horizontal building material the kit now covers. The top covers 210a, 210b may be fastened to the header of the existing structure with plastic barb fasteners, double sided adhesive, adhesive, silicone, or clips, for example, to allow for movement and permanent fastening that is also removable or re-installable for future needs. For example, FIG. 5 shows a method of using a barb fastener 510 to secure a top cover 210a to the existing header above the garage door opening. According to an example embodiment, if the original structure is not masonry then the topside lip of the top cover 210a may be omitted and the top cover 210a may be affixed to the existing structure with construction adhesive or plastic barb fasteners.

Referring again to FIG. 4, the coupling component 220 may be L-shaped, and may cover a center expansion/contraction space left between the two cover pieces 210a, 210b during installation, which allows the two top covers 210a, 210b to accommodate the existing structure expanding and contracting in extreme weather conditions. The coupling component 220 may be fastened to the existing header with, for example, barb fasteners, double-sided adhesive, adhesive, silicone, and clips to allow for movement, and permanent fastening mechanisms that may also be removable or re-installable for future needs.

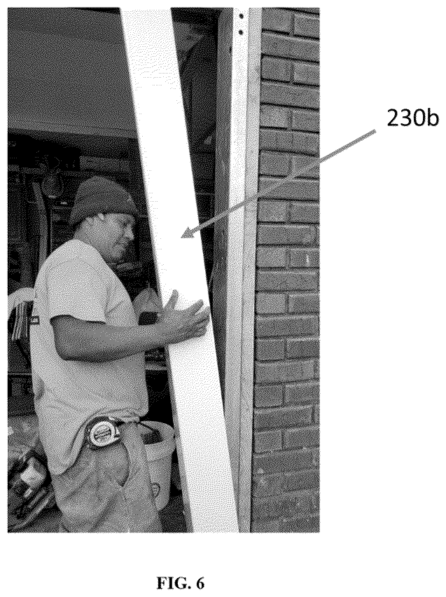

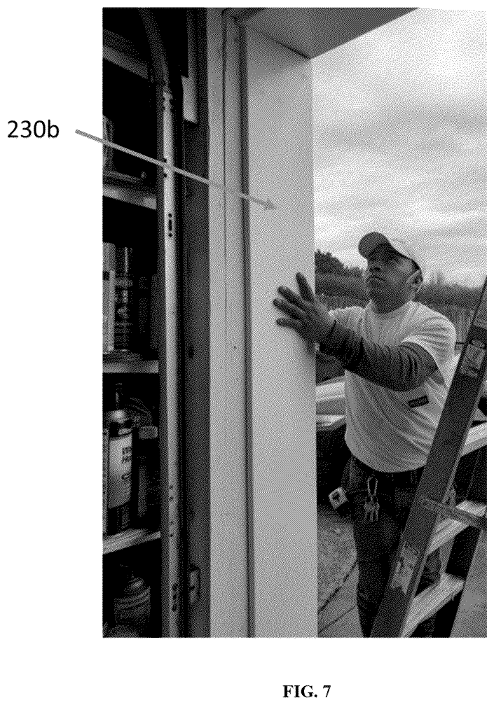

FIG. 6 shows a side cover according to an example embodiment, and FIG. 7 shows a method of installing the side cover according to example embodiment. Referring to FIGS. 6 and 7, the side covers 230b may have an L-shaped cross section that covers the front vertical surface of the structure and wraps around the vertical trim material of the existing surface, sealing the existing building material (including metal fasteners) against water, rust erosion and air infiltration (weather), as well as sun damage. The side covers 230b may be affixed to the existing structure at each side of the garage door opening 100 using, for example, barb fasteners, double sided adhesive, adhesive, silicone, or clips to allow for movement, or permanent fastener mechanisms that may be removable or re-installable for future needs.

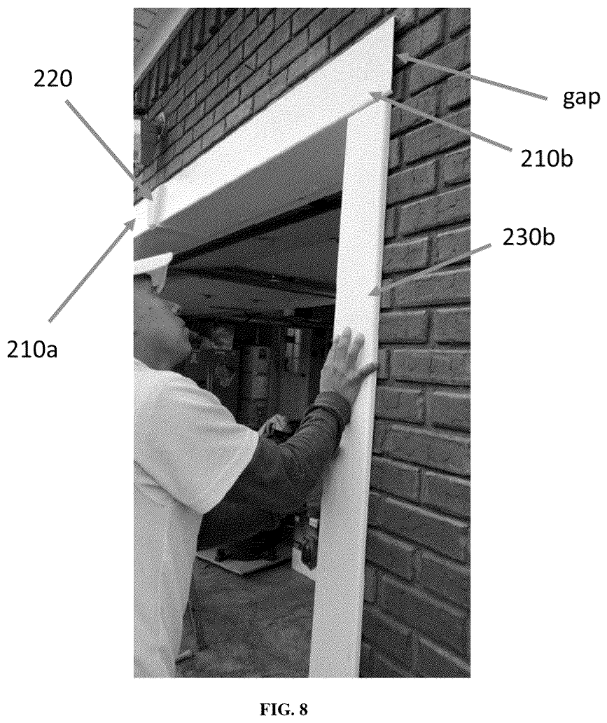

FIG. 8 shows an external side view of top covers 210a, 210b and a side cover 230baccording to an example embodiment, after installation is complete. As shown in FIG. 8, at the end of top cover 210b there may be a gap between the vertical face of the top cap 210b and the existing structure, which may be covered by an end cap (shown in later drawing) that may be press fit into each end of the top cover 210b. The end caps may also be affixed to the ends of the top cover 210b (and 210a) with, for example, silicone, construction adhesive, double sided adhesive, or clips to seal the top cover 210b and existing structure from water and air infiltration, insects, and sun damage.

The top covers 210a, 210b, side covers 230a, 230b, and coupling component 220 may be ultra-violate (UV) protected so it can be used without paint, or can be painted to alter their color. The surface of the components may be paintable and the texture finish of the components may also vary.

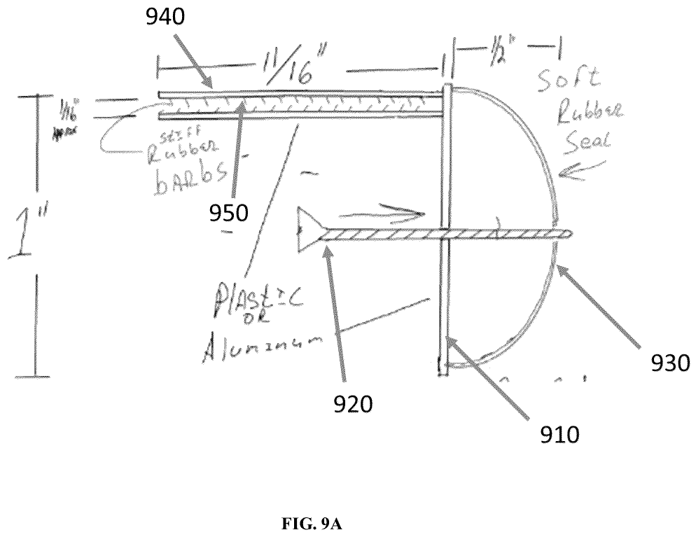

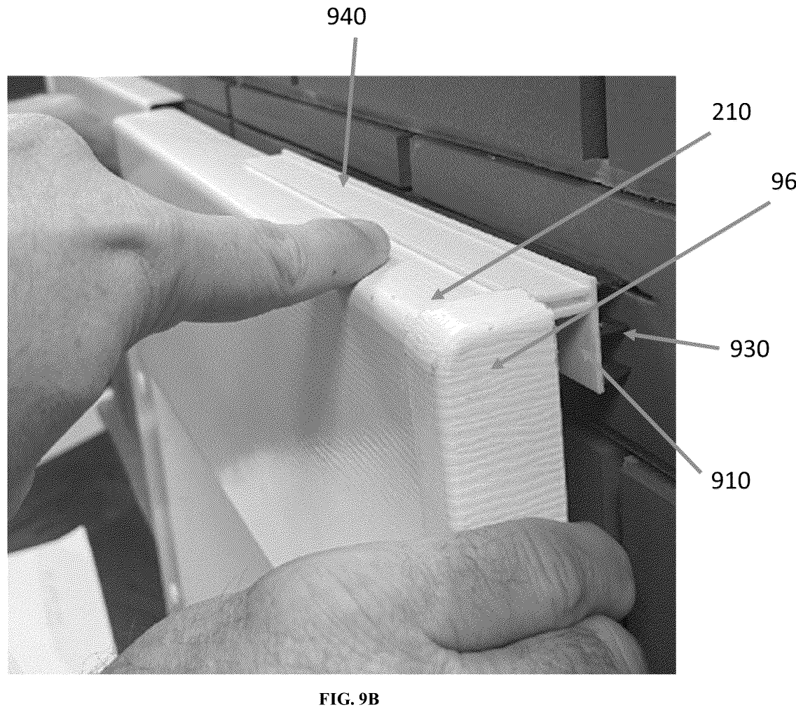

FIG. 9A illustrates a side view of a top clip track for securing a vertical face of a top cover for a lintel above a garage door opening according to an example embodiment. FIG. 9B shows a perspective view of the top clip track of FIG. 9A, with a top cover being inserted into the top click track. According to an example embodiment, a top cover 210 may be installed to cover a lintel above a structural opening, e.g., a garage door opening, without cutting into the existing structure above the opening. Referring to FIGS. 9A and 9B, a top clip track according to an example embodiment may include a mounting portion 910 that may be sized and shaped to be mounted to a face of the existing structure (not shown). As shown in FIGS. 9A and 9B, the mounting portion 910 may be vertically disposed, and may be secured to the face of the existing structure using one or more screws 920, though a bolt, nail, adhesive or other suitable coupling mechanism may be used. The mounting portion 910 may include a seal portion 930, which may be affixed to a back side of the mounting portion 910 using, for example, various adhesive materials. The seal portion 930 may be made of a resilient material, and may be sized and shaped to abut against a mortar joint, for example, between one or more bricks, or other masonry or stone material. In the example shown in FIG. 9A, the seal portion 930 may be approximately D-shaped when viewed from the side before being compressed. In the example shown in FIG. 9B, the seal portion 930 may have a ribbed configuration, with multiple portions contacting the structure, and recesses between the contacting portions. As the mounting portion 910 is secured to the face of the existing structure, for example via one or more screws 920, the seal portion 930 may be compressed as the mounting portion 910 is tightened against the face of the existing structure. The seal portion 930 may create a moisture-proof seal between the seal portion 930 and the face of the existing structure that may prevent moisture from entering therebetween. Although the present example embodiment is described in the context of use with existing structures having brick or masonry joints, the example clip track may be used with an existing structure having any other type of surface. For example, according to various examples, the seal portion 930 may be omitted and the mounting portion may be affixed to the surface of the structure using, for example, various adhesive materials.

The top clip track according to various examples may also include a retaining portion 940, which may extend at a substantially right angle with respect to a front side (i.e., opposite side of the seal portion) of the mounting portion 910, though other angles may be used. The retaining portion 940 may be located at or near and end of the mounting portion 910, such as a top end of the mounting portion 910, as shown in FIGS. 9A, 9B. The retaining portion 940 may be sized and shaped to securely receive a topside lip of a top cover 210, which may be press fit into the retaining portion 940. The retaining portion 940 may include one or more barbs 950 that are sized and shaped to engage the topside lip of the top cover 210. For example, the retaining portion 940 may include a plurality of barbs 950 made of a rubber or similarly suitable material. The plurality of barbs 950 may be disposed at an angle to resist an attempt to pull the topside lip of the top cover 210 out of the retaining portion 950 after the top side lip of the top cover 210 has been inserted. For example, the barbs 950 may extend from opposing inner walls of the retaining portion 940 at an angle toward the mounting portion 910. When the topside lip of the top cover 210 has been inserted into the retaining portion 940, the plurality of barbs 950 may securely retain the topside lip of the top cover 210, and a horizontal face of the top cover 210 wraps underneath and over the down-facing surface of the existing structure above the opening in the structure. An end cover 960 may be affixed to an end portion of the top cover 210, for example, by press fit. The end cover 960 may cover the ends of the mounting portion 910 and the retaining portion 940, and any gap between the vertical face of the top cover 210 and the existing structure. According to various examples, the plurality of barbs 950 may engage the top cover 210 to create a seal that may be water resistant or waterproof. For example, the plurality of barbs may be made of a resilient material such as rubber that may deflect as the topside lip of the top cover 210 is inserted into the retaining portion 940 and create a seal by engaging the topside lip of the top cover 210. According to various examples, the plurality of barbs 950 may be disposed on top and bottom portions of the retaining portion 940, and the top barbs may be staggered with respect to the bottom barbs.

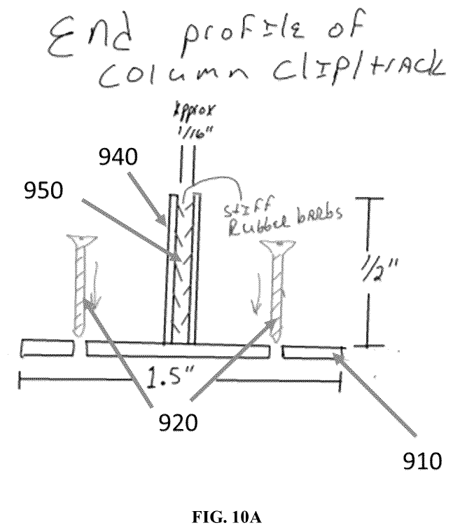

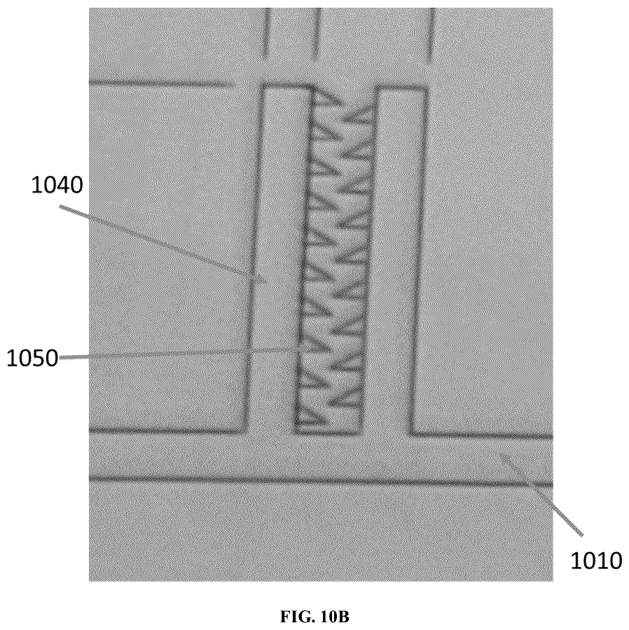

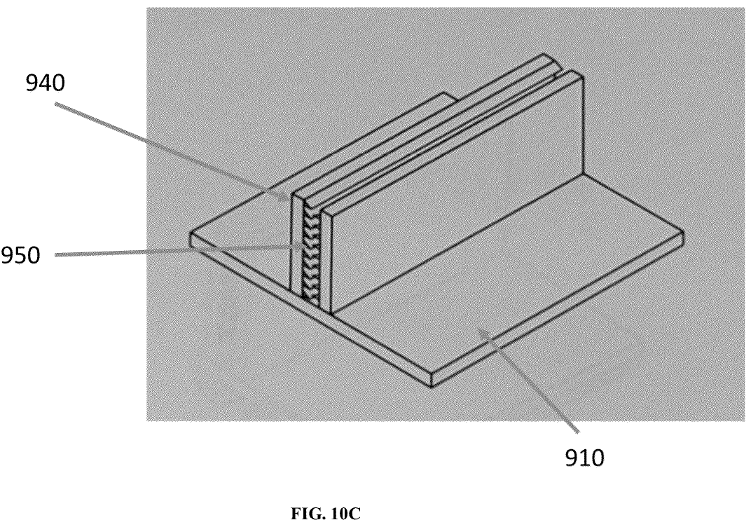

The horizontal face of the top cover 210 may be secured to the down-facing surface of the existing structure above the opening in the structure via various suitable coupling mechanisms, such as one or more screws, nails, bolts, adhesives, etc. Alternatively, the horizontal face of the top cover 210 may be secured to the down-facing surface of the existing structure above the opening in the structure using the side clip track shown in FIGS. 10A-10C, discussed below. In particular, the top cover 210 may have a bottom lip that may be used to secure the horizontal face of the top cover 210 to the down-facing surface of the existing structure above the opening in the structure. The top clip track according to an example embodiment may extend across the entire span of the opening in the existing structure, or across a portion thereof. For example, for a 16-foot garage door opening, two 8-foot top clip tracks may be used to span the entire garage door opening. Screws 920 may be used to affix the top clip tracks to the existing structure at various intervals, for example every 8 inches, though other intervals may be used. The retaining portion 940 of the top clip track may allow the top cover 910a to be securely affixed to the existing structure without cutting a reglet or groove into the existing structure.

FIGS. 10A and 10B illustrate end views of a side clip track for securing a side cover 230a/230b to a side of a garage door opening 100, and the horizontal face of the top cover 910 to the down-facing surface of the existing structure above the opening in the structure, according to various examples. FIG. 10C shows a perspective view of the side clip track shown in FIGS. 10A and 10B. Similar to the top clip track shown in FIGS. 9A-9B for securing a top cover a front face of an existing structure above an opening in the existing structure 100, the side clip track shown in the example of FIGS. 10A-10C may include a mounting portion 1010 that is sized and shaped to be affixed to a side of an opening in an existing structure 100, such as a garage door opening. The mounting portion 1010 may also be sized and shaped to be affixed to the down-facing surface of the existing structure above the opening in the structure. The mounting portion 1010 maybe affixed to the side of the opening in the existing structure 100 using one or more screws 1020, though bolts, nails, adhesive, or other suitable coupling mechanism may be used. More specifically, a side clip track may be mounted, via the mounting portion 1010, to a front vertical face of the structure located on the sides of the structural opening (e.g., side of a garage door opening). A second side clip track may be mounted on the side vertical surface of the structure that faces toward the structural opening, and is opposite the other side of the opening.

The mounting portion 1010 may have a retaining portion 1040 that extends from the mounting portion 1010. For example, the retaining portion 1040 may extend at approximately 90 degrees relative to the mounting portion 1010 of the clip track. The retaining portion 1040 may be located approximately near the center of the mounting portion 1010. The retaining portion 1040 may be sized and shaped to securely receive a lip of a side cover 230a/230b, which may be press fit into the retaining portion 940. The side cover 230b may be L-shaped, and may have first and second lips at or near respective ends of the L-shaped cover that are configured to be received by respective side clip tracks mounted on the front and side faces of each side of the structural opening.

The retaining portion 1040 may include one or more barbs 1050 that are sized and shaped to engage the lip of the side cover 230a/230b. For example, the retaining portion 1040 may include a plurality of barbs 1050 made of a rubber or similarly suitable material. The plurality of barbs 1050 maybe disposed at an angle to resist an attempt to pull the lip of the side cover 230a/230b out of the retaining portion 1040 after the side cover 230a/230b has been inserted. For example, the barbs 1050 may extend from opposing inner walls of the retaining portion 1040 at an angle toward the mounting portion 1010. When the first lip of the side cover 230a/230b has been inserted into the retaining portion 1040, the plurality of barbs 1050 may securely retain the lip of the side cover 230a/230b, and a second vertical face of the side cover 230a/230b wraps around a side vertical face of the existing structure where a second lip secures the second vertical face of the side cover 230a/230b to the existing structure via a retaining portion of a second side clip track. According to various example embodiments, the mounting portion 1010 maybe affixed to the front face of the existing structure, such that the second vertical face is disposed to cover the side vertical face of the structural opening, which may be disposed 90 degrees relative to the front face.

As explained above, multiple side clip tracks may be used to secure the two vertical faces of the side cover 230a/230b to the respective front and vertical side faces of the structural opening. The side clip track according to an example embodiment may extend for the entire height of the opening 100 in the existing structure, or a portion thereof. For example, for an 8-foot tall garage door opening, two 4-foot clip tracks may be used to span the entire garage door opening. Screws 1020 may be used to affix the side clip tracks to the existing structure at various intervals, for example every 8 inches, though other intervals may be used. The retaining portion 1040 of the side clip track may allow the side cover 230b to be securely affixed to the existing structure without cutting a reglet or groove into the existing structure.

In addition, the side clip track may be mounted on the down-facing surface of the existing structure above a garage door opening to secure the horizontal surface of the L-shaped top cover 210a, 210b. The side clip track may be mounted such that the retaining portion 1040 extends vertically downward toward the ground. The inner surface of the L-shaped top cover 210a, 210bmay include a bottom lip that perpendicularly extends towards the downward facing horizontal surface of the existing structure when the L-shaped top cover 210a, 210b is mounted. The retaining portion 1040 and the plurality of barbs 1050 contained therein may be configured to receive and engage the bottom lip formed on the inner side of the L-shaped top cover 210a, 210b. Because the bottom lip is formed on the inner side of the L-shaped top cover 210a, 210b, the bottom lip and the side clip track may be hidden from view when the L-shaped top cover 210a, 210b is fully installed.

Various examples have been disclosed herein, in connection with the above description and the drawings. It will be understood that it would be unduly repetitious to literally describe and illustrate every combination and subcombination of these examples. Accordingly, all examples can be combined in any way and/or combination, and the present specification, including the drawings, shall be construed to constitute a complete written description of all combinations and subcombinations of the examples described herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A trim kit for a structural opening in a structure, the trim kit comprising:
a first top cover configured to be affixed to the structure above the structural opening; and
a first side cover configured to be affixed to a lateral side of the structure adjacent to the structural opening;
wherein at least one of the first top cover and the second top cover include a topside lip that is configured to fit within a groove in the structure above or on the lateral side of the structural opening.

2. The trim kit of claim 1, further comprising a second top cover configured to be affixed to the structure above the structural opening; and
a coupling component configured to be coupled to and between the first top cover and the second top cover.

3. The trim kit of claim 1, wherein the first top cover is L-shaped, and configured to cover front and bottom faces of the existing structure above the structural opening.

4. The trim kit of claim 2, wherein the first top cover and the second top cover are L-shaped, and configured to cover front and bottom faces of the existing structure above the structural opening.

5. The trim kit of claim 4, wherein the coupling component is L-shaped.

6. A trim kit for a structural opening in a structure, the trim kit comprising:
a top cover configured to be affixed to the structure above the structural opening;
a side cover configured to be affixed to a side of the structure laterally adjacent to the structural opening; and
a top clip track comprising:
a mounting portion configured to be affixed to a front surface of the structure above the opening in the structure; and
a retaining portion extending outwardly from the mounting portion and configured to receive a topside lip of the top cover.

7. The trim kit of claim 6, wherein the retaining portion of the top clip track extends at approximately a 90 degree angle from the mounting portion of the top clip track.

8. The trim kit of claim 6, wherein the retaining portion of the top clip track includes a plurality of barbs to retain the topside lip of the first top cover.

9. The trim kit of claim 8, wherein at least some of the plurality of barbs are made of a resilient material, and are oriented toward the mounting portion of the top clip track to resist removal of the topside lip from the mounting portion of the top clip track.

10. The trim kit of claim 6, wherein the top clip track comprises a seal portion affixed to a side of the mounting portion of the top clip track that is opposite the retaining portion of the top clip track.

11. The trim kit of claim 6, further comprising a first side clip track comprising a mounting portion configured to be affixed to a down-facing surface of the structure above the opening in the structure, and a retaining portion extending outwardly from the mounting portion and configured to receive a bottom lip of the top cover.

12. The trim kit of claim 11, further comprising second and third side clip tracks to affix the side cover to the side of the structure laterally adjacent to the structural opening, wherein the second side clip track comprises a mounting portion configured to be affixed to a front face of the structure laterally adjacent to the structural opening, and a retaining portion extending outwardly from the mounting portion and configured to receive a first side lip of the side cover; and
wherein the third side clip track comprises a mounting portion configured to be affixed to a vertical side face of the structure laterally adjacent to the structural opening that is perpendicular to the front face, and a retaining portion extending outwardly from the mounting portion of the third side clip track, and configured to receive a second side lip of the side cover.

13. The trim kit of claim 12, wherein the retaining portions of the first, second, and third side clip tracks respectively include a plurality of barbs that are oriented toward their respective retaining portions.

14. A method of installing a trim kit for a structural opening in a structure, the method comprising:
affixing a top clip track to the structure above the structural opening, wherein the top clip track comprises:
a mounting portion configured to be affixed to a front surface of the structure above the opening in the structure; and
a retaining portion extending outwardly from the mounting portion and configured to receive a topside lip of a top cover.
inserting a topside lip of the top cover into the retaining portion; and
affixing the top cover to a down-facing surface of the structure above the structural opening.

15. The method of claim 14, wherein the step of affixing the top cover to a down-facing surface of the structure above the opening in the structure comprises:
affixing a first side clip track to the down-facing surface of the structure above the structural opening, wherein the first side clip track comprises:
a mounting portion configured to be affixed to a down-facing surface of the structure above the structural opening; and
a retaining portion extending outwardly from the mounting portion and configured to receive a bottom lip of the top cover; and
inserting the bottom lip of the top cover into the retaining portion of the side clip track.

16. The method of claim 15, further comprising:
affixing a second side clip track to a front vertical face of the structure laterally adjacent to the opening in the structure;
affixing a third side clip track to a side vertical face of the structure that is perpendicular to the front vertical face of the structure; and
coupling a side cover to the second and third side clip tracks;
wherein the second side clip track includes a mounting portion configured to be affixed to the front vertical face of the structure, and a retaining portion extending outwardly from the mounting portion of the second side clip and configured to receive a first lip of the side cover; and
wherein the third side clip track includes a mounting portion configured to be affixed to the side vertical face of the structure, and a retaining portion extending outwardly from the mounting portion of the third side clip and configured to receive a second lip of the side cover.

17. The method of claim 14, wherein the retaining portion of the top clip track extends at approximately a 90 degree angle from the mounting portion.

18. The method of claim 14, wherein the retaining portion of the top clip track includes a plurality of barbs to retain the topside lip of the top cover.

19. The method of claim 16, wherein at least some of the plurality of barbs of the top clip track are made of a resilient material, and are oriented toward the mounting portion to resist removal of the topside lip from the mounting portion.

20. A clip track for securing a trim piece to an existing structure, the clip track comprising:
a mounting portion configured to be affixed to a surface of an existing structure;
a retaining portion extending from a front side of the mounting portion, and configured to receive a lip of the trim piece;
a seal portion made of a resilient material and affixed to a back side of the mounting portion; and
a plurality of barbs disposed within the retaining portion, and configured to retain the lip of the trim piece.
